(19) United States
(12) Patent Application Publication
(10) Pub. No.: US 2023/0412104 A1
(43) Pub. Date: Dec. 21, 2023

(54) MULTIPHASE WINDING ARRANGMENT IN ELECTRIC MACHINES FOR MITIGATING SHORT-CIRCUIT FAULT CURRENTS

(71) Applicant: Board of Regents, The University of Texas System, Austin, TX (US)

(72) Inventors: Matthew C. Gardner, Austin, TX (US); Ahmad Daniar, Austin, TX (US); Prasad Enjeti, Austin, TX (US)

(21) Appl. No.: 18/332,561

(22) Filed: Jun. 9, 2023

Related U.S. Application Data
(60) Provisional application No. 63/353,221, filed on Jun. 17, 2022.

(51) Int. Cl. H02P 25/22; H02K 3/28

(52) U.S. Cl. CPC H02P 25/22; H02K 3/28; H02P 2207/055

(57) ABSTRACT

An electrical machine including a stator. The stator includes slots to house conductors, the conductors arranged in the slots to provide a winding arrangement where: turns of a first conductor winding are not adjacent to each other, turns of a second conductor winding are not adjacent to each other, and the turns of the first conductor winding and the turns of the second conductor winding do not share a common neutral point and are not connected to each other in series or parallel.

### CROSS-REFERENCE TO RELATED APPLICATION

This application claims the benefit of U.S. Provisional Application Ser. No. 63/353,221, filed by Matthew C. Gardner, et al. on Jun. 17, 2022, entitled “MULTIPHASE WINDING ARRANGEMENT IN ELECTRIC MACHINES FOR MITIGATING SHORT-CIRCUIT FAULT CURRENTS,” commonly assigned with this application and incorporated herein by reference in its entirety.

### STATEMENT OF GOVERNMENT INTEREST

This invention was made with government support under contract number DE-AR0001356 awarded by the Department of Energy. The government has certain rights in the invention.

### TECHNICAL FIELD

This application is directed, in general, to electric machines, and more specifically, electric machines having multiple conductive windings.

### BACKGROUND

In electrical machines (e.g. motors and generators), the insulation on the windings tends to degrade over time and can eventually fail, resulting in faults (short circuits). In the case of a fault, the varying magnetic flux in the electric machine can induce large currents in the windings, which causes rapid heating that can damage the electric machine and start a fire. These large fault currents are especially problematic for permanent magnet machines, where the magnetic flux cannot be removed in the case of a fault. In particular, surface permanent magnet machines have low inductances, which can lead to especially large fault currents. Thus, despite their high power density and high efficiency, surface permanent magnet machines have failed to gain much traction in applications with large inertias (e.g. flywheels) or stringent safety requirements (vehicles). However, while less catastrophic for other types of machines, these fault currents will still generally require the machine to cease operation or to operate at significantly reduced performance.

### SUMMARY

The present disclosure provides an electrical machine including a stator. The stator includes slots to house conductors, the conductors arranged in the slots to provide a winding arrangement where: turns of a first conductor winding are not adjacent to each other, turns of a second conductor winding are not adjacent to each other, and the turns of the first conductor winding and the turns of the second conductor winding do not share a common neutral point and are not connected to each other in series or parallel.

### BRIEF DESCRIPTION OF FIGURES

For a more complete understanding of the present disclosure, reference is now made to the following detailed description taken in conjunction with the accompanying FIGUREs, in which:

FIG. 1 presents schematic illustrations for: (A) a machine with a 10-slot, 12-pole motor with two sets of three-phase windings, (B) placement of the conductors in two of the slots according to an embodiment of the disclosed arrangement, and (C) the equivalent circuit for the machine during healthy operation and supplied by a six-phase voltage source inverter;

FIG. 2 presents schematic illustrations for: (A) a motor with a conventional winding configuration and (B) a motor with an embodiment of the disclosed winding configuration;

FIG. 3 presents example plots of: (A) an A1 turn back-emf versus mechanical angle and (B) apparent self-inductance of the A1 turn, for both a conventional machine and an embodiment of the disclosed machine;

FIG. 4 presents a schematic illustration of an equivalent circuit model of a conventional three-phase permanent magnet synchronous machine with an inter-turn short circuit fault in phase A;

FIG. 5 presents a schematic illustration of: (A) placement of the conductors in one of the slots according to a conventional arrangement and (B) an example plot of inter-turn short circuit fault current for an A1 to A2 short circuit versus mechanical angle in the conventional winding arrangement;

FIG. 6 presents a schematic illustration of the equivalent circuit model of an embodiment of the disclosed winding configuration for an A1-X1 inter-turn short circuit fault;

FIG. 7 presents a plot of an A1-X1 inter-turn short circuit fault current of an embodiment of the disclosed winding configuration versus mechanical angle if the voltage source inverter continues supplying the same voltages;

FIG. 8 presents a schematic illustration of the equivalent circuit model of an embodiment of the disclosed winding configuration for an A2-X1 inter-turn short circuit fault;

FIG. 9 presents an example plot of an A2-X1 inter-turn short circuit fault current of an embodiment of the disclosed winding configuration versus mechanical angle;

FIG. 10 presents example plots of an A4-X4 and A8-X8 inter-turn short circuit fault current of an embodiment of the disclosed winding configuration versus mechanical angle;

FIG. 11 presents example plots of an A7-A8 and A15-A16 inter-turn short circuit fault current of an embodiment of the disclosed winding configuration versus mechanical angle;

FIG. 12 presents an example plot of a compensated fault current for a A1-X1 inter-turn short circuit fault current of an embodiment of the disclosed winding configuration versus mechanical angle;

FIG. 13 presents an example plot of a compensated fault current for A4-X4 inter-turn short circuit fault current of an embodiment of the disclosed winding configuration versus mechanical angle; and

FIG. 14 presents an example plot of output torque versus mechanical angle in healthy conditions, with the A1-X1 inter-turn short circuit fault, and with the A1-X1 inter-turn short circuit fault of an embodiment of the disclosed winding configuration and the voltage compensation.

### DETAILED DESCRIPTION

In an embodiment of the present invention, the turns of windings in an electric machine can be arranged so that no turn is adjacent to another turn of the same phase or a turn of a phase sharing a common neutral point. This could be achieved, for example, using a symmetric multiphase arrangement with independent neutral points. This winding arrangement allows the drive to block the fault currents originating from short-circuit faults within the machine. However, the fault current can also be mitigated without disconnecting the affected phases, so that the motor can continue operating near its nominal ratings. In a related embodiment, one way to mitigate this fault current is contemplated wherein a current source inverter is used to supply the electric machine with the contemplated winding arrangement. In another related embodiment, wherein a voltage source inverter is used to supply the electric machine with the contemplated winding arrangement, various techniques can be used to reduce the fault current. Said various techniques comprise changing the magnitude or phase of the voltage supplied to one or both of the affected phases, injecting harmonics into the voltage supplied to one or more of the affected phases, or adding zero-sequence voltage to some of the phases in the motor. Additionally, in another embodiment of the present invention, the fault currents are reduced by adding inductors or chokes to the drive. Said inductors or chokes could be added on the lines going directly from the drive to the electric machine or on the DC lines supplying various legs of the inverter.

As further disclosed herein, various embodiments of the present invention are presented in the attached manuscript which serves as a specification for purposes of illustration, but are not intended to be exhaustive or limited to the embodiments disclosed or claimed. Many modifications and variations will be apparent to those of ordinary skill in the art without departing from the scope and spirit of the described embodiment. The terminology used herein is chosen to best explain the principles of the embodiment, the practical application or technical improvement over technologies found in the marketplace, or to enable others of ordinary skill in the art to understand the embodiments disclosed here.

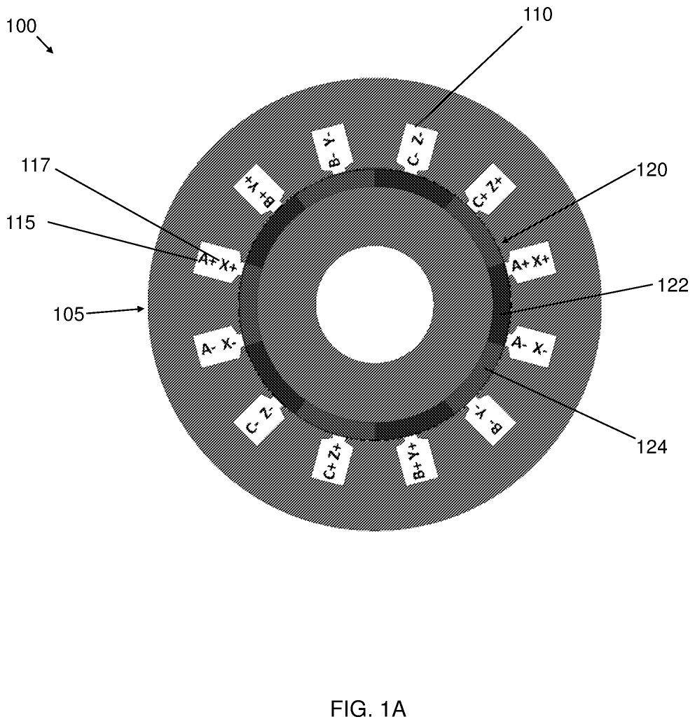

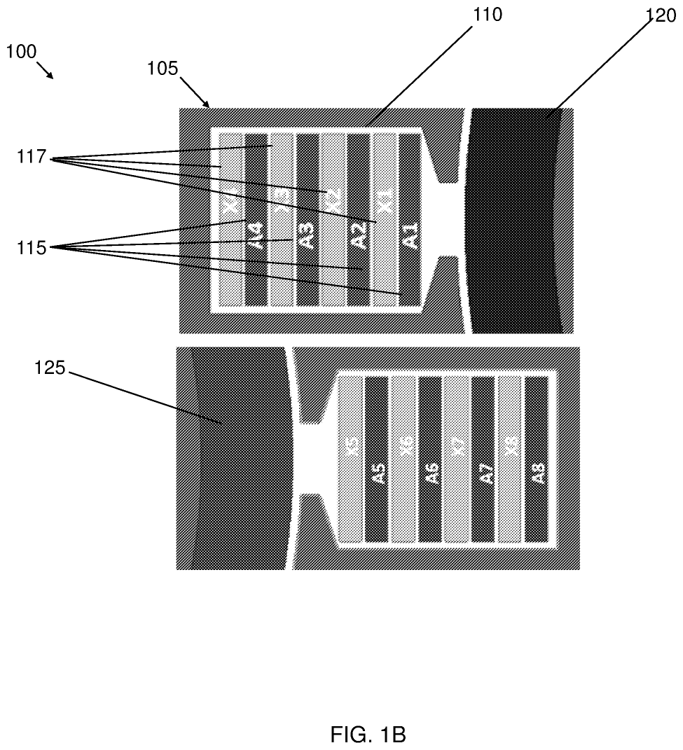

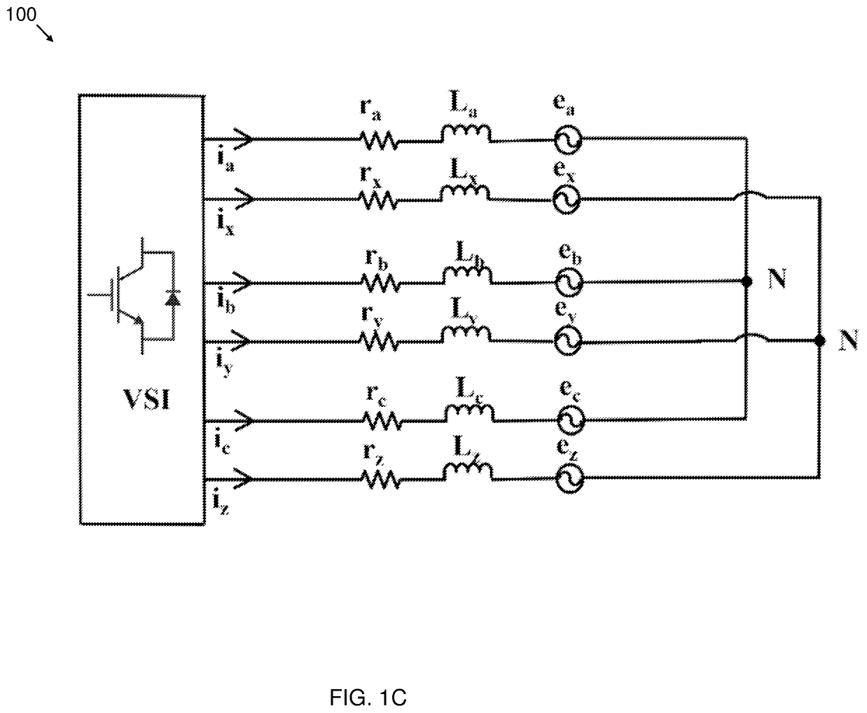

With reference to FIGS. 1A-1C, one embodiment is an electrical machine 100 that includes a stator 105. The stator including slots 110 to house conductors 115, 117, the conductors arranged in the slots to provide a winding arrangement where: turns of a first conductor 115 winding (e.g., A1, A2, . . . A8) are not adjacent to each other, turns of a second conductor 117 winding (e.g., X1, X2, . . . X8) are not adjacent to each other, and the turns of the first conductor winding and the turns of the second conductor winding do not share a common neutral point and belong to different phases, which means the first conductor is not connected to the second conductor in series or parallel.

In some embodiments, the electrical machine further including a rotor 120 where the stator can be situated within the rotor, stator can be situated axially beyond the rotor or the stator can be situated around the rotor. In some such embodiments, the rotor can be or include a permanent magnet 122. In some such embodiments, the rotor can include two magnets 122, 124 that are arranged to have opposite polarity alignments with respect to each other.

In any such embodiments, the electrical machine can be or includes a motor or a generator.

In any such embodiments, the electrical machine can further include a current source inverter to drive the electric machine with the winding arrangement.

In any such embodiments, the electrical machine can further include a voltage source inverter (VSI) to drive the electric machine with the winding arrangement.

In some such embodiments, a magnitude or a phase of a voltage supplied by the voltage source inverter to one of the first conductor or to the second conductor is different from the magnitude or a phase of a voltage supplied by the voltage source inverter to the other one of the second conductor or to the first conductor. Some such embodiments can include an inductor or a choke connected between the voltage source inverter and the first conductor or the second conductor. Some such embodiments can include an inductor or a choke connected to a DC voltage line to the voltage source inverter.

In any such embodiments, the turns of the first conductor can be interleaved with the turns of the second conductor.

Electric machines can experience various types of short-circuit faults when the insulation fails. Inter-turn short-circuit (ITSC) faults can be particularly hazardous for surface-mounted permanent magnet (SPM) machines. This disclosure proposes a multiphase winding configuration to mitigate ITSC fault currents. With the proposed winding arrangement, ITSC faults become phase-phase faults and can be blocked by the drive. Alternatively, control actions can reduce the fault current and allow the machine to continue normal operation. Short-circuit faults between turns are evaluated using finite element analysis for an example 12-slot, 10-pole SPM machine. The case study demonstrates that the proposed winding arrangement reduces the short-circuit fault from 5400% of the nominal current to 46%, in some cases, even without any adjustment of the control. Additionally, adjusting the voltages supplied to the affected phases can further reduce the short-circuit current to 10.5% of the nominal current with a negligible impact on the torque.

Some terms as used herein include: fault current mitigation, fault tolerance, inter-turn short-circuit (ITSC) faults, multiphase electric machines, permanent magnet machines, phase-to-phase faults, reliability, short-circuit currents, winding configurations.

Increasingly, high torque densities and efficiencies are being demanded of electric machines to meet modern applications from electric aviation and electric vehicles to renewable energy generation. Thus, permanent magnet synchronous machines (PMSMs) are achieving increasingly widespread adoption, especially in electric traction applications (1). While PMSMs can achieve very high torque densities and efficiencies, the uncontrolled permanent magnet (PM) excitation presents a challenge for achieving high reliability designs (2). In order to meet the demands for higher power density, the electric machine is subjected to higher electrical, mechanical, and thermal stresses. For example, due to the very fast switching capabilities of wide-band-gap (WBG) devices, an increased voltage gradient is applied to the electric machines winding, which puts more electrical stress on winding insulation (3). Similarly, allowing the windings to operate at higher temperatures reduces the insulation lifespan. As the insulation of the winding degrades over time, the probability of a short circuit fault occurring increases. A short circuit fault can produce large currents, which cause temperatures to rise rapidly. This can cause the fault to cascade and quickly cause complete failure and shut down of the machine. Electric machine windings are prone to different kinds of short circuit faults, including phase-ground, phase-phase, and inter-turn short circuit (ITSC). ITSC faults are particularly dangerous in surface mounted permanent magnet (SPM) machines because SPM machine windings tend to have low inductances, so the ITSC fault currents can be very large (4)-(5). Furthermore, even if the stator excitation is removed, the PMs continue to excite a large circulating fault current, which rapidly converts the kinetic energy of the system into heat. This rapid heating can cause cascading faults, demagnetization of the PMs, or even fires. As a result, SPM machines could be disqualified for high reliability applications even though they achieve among the highest torque densities. On the other hand, for induction or wound-field synchronous machines, the rotor excitation can be removed or reduced to prevent or diminish the circulating current, although this prevents the machine from continuing its normal operation (6).

The need for fault tolerant traction drives and machines has inspired researchers to propose a variety of analysis approaches and solutions. Some researchers have found equivalent circuit models useful for exploring system dynamics during operation with faults. Such models use machine parameters determined either analytically or with finite element analysis (FEA) (7)-(10). Many authors have investigated multiphase drives and electric motors for fault tolerant applications. In case of an open-circuit fault, the motor can continue normal operation at reduced power using the remaining healthy phases (11)-(15). However, multiphase systems do not solve the problem of large ITSC fault currents. Various diagnostic methods for detecting ITSC faults in PMSMs have been introduced (16)-(21). Once the fault is diagnosed, the ITSC fault current can be reduced by injecting d-axis current to oppose the flux from the PMs (22)-(23). However, this increases the copper losses and derates the machine. Additionally, while this strategy may have some benefit for interior permanent magnet (IPM) machines, a much larger d-axis current would be required for SPM machines, which tend to have smaller inductances.

Herein discloses a multiphase winding arrangement that can inherently reduce or block fault currents resulting from insulation failure between adjacent turns. In the following sections, the proposed configuration will be presented and a case study evaluated using FEA to investigate the effectiveness of the winding arrangement.

A new winding arrangement is proposed to address ITSC faults in motors with form-wound windings, which often involve rectangular conductors. Form-wound windings with rectangular conductors can achieve high slot fill factor, which improves torque density and efficiency (24)-(25). Additionally, rectangular conductors achieve better thermal contact than round conductors, improving heat dissipation from the conductors (24). Thus, rectangular conductors are common in traction motors and large machines (24)-(25).

For the proposed winding arrangement, the conductors are arranged in such a way that no conductor is adjacent in the slots or end windings to another conductor of the same phase or of a phase that shares a connection within the motor. Thus, any short-circuit fault between adjacent conductors is a phase-phase fault rather than an ITSC fault. Additionally, any short-circuit fault current must flow through the drive and cannot circulate only inside the motor. Thus, if a current source inverter (CSI) is used to drive the motor, the fault current will be zero as long as the CSI continues to supply the nominal currents to each phase, and the system can continue normal operation. Alternatively, if a voltage source inverter (VSI) is used to drive the motor, the VSI can block the fault current by opening the switches of the affected phases; then, the system can continue operating with reduced power. However, in some cases, the VSI may be able to adjust the voltage supplied to one or both of the affected phases to reduce the fault current to an acceptable level while still maintaining close to the nominal currents in the affected phases, allowing the system to continue operating near its nominal conditions.

FIGS. 1A-1C shows an example of the proposed winding arrangement with two sets of three-phase windings in a 12-slot, 10-pole motor. The two sets are not phase shifted from each other, and they do not share a common neutral point. A VSI is used to drive all six phases. As can be seen from FIGS. 1A-1C, with this arrangement, any ITSC fault becomes a phase-phase fault, and the fault current can be blocked by the VSI.

However, the proposed winding arrangement does have some disadvantages. As with all multiphase machines, the complexity is increased as more current sensors, gate drivers, and switches are required, although each switch can be rated for a lower voltage. Additionally, the motor may be more difficult to wind because turns from two phases must alternate in each slot. While the proposed configuration allows the drive to block the short-circuit fault current produced by a single short-circuit fault, in the event of multiple short-circuit faults, there may be a fault current loop completely inside the machine. In this case, the fault current can freely flow in that loop without the drive being able to block the fault current.

A. Description of Evaluated Motor

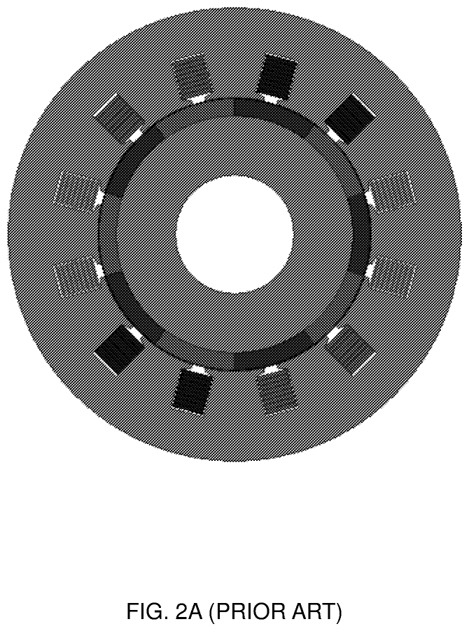

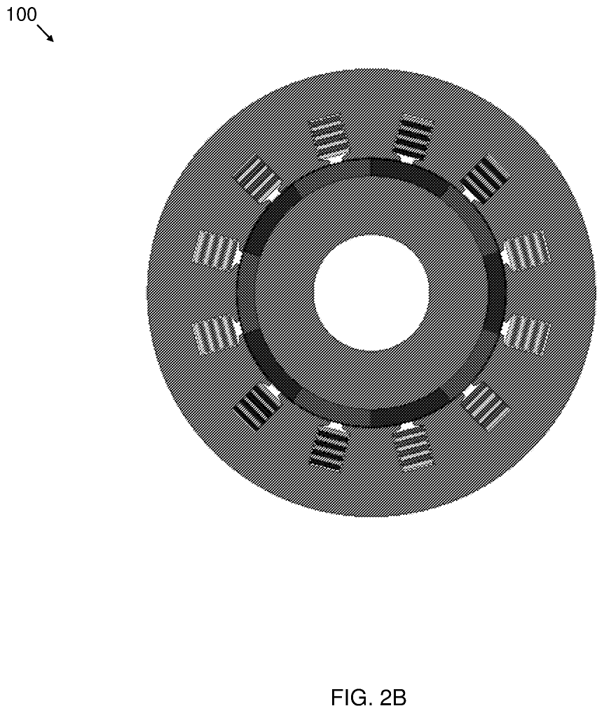

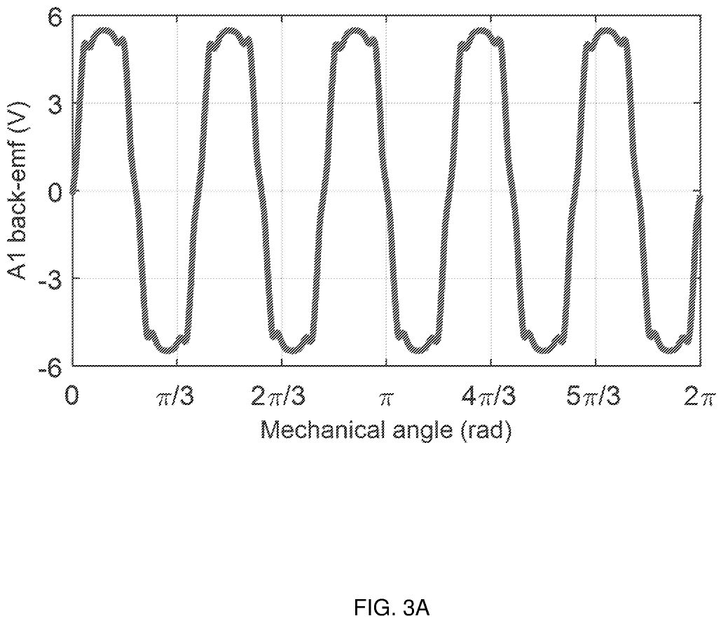

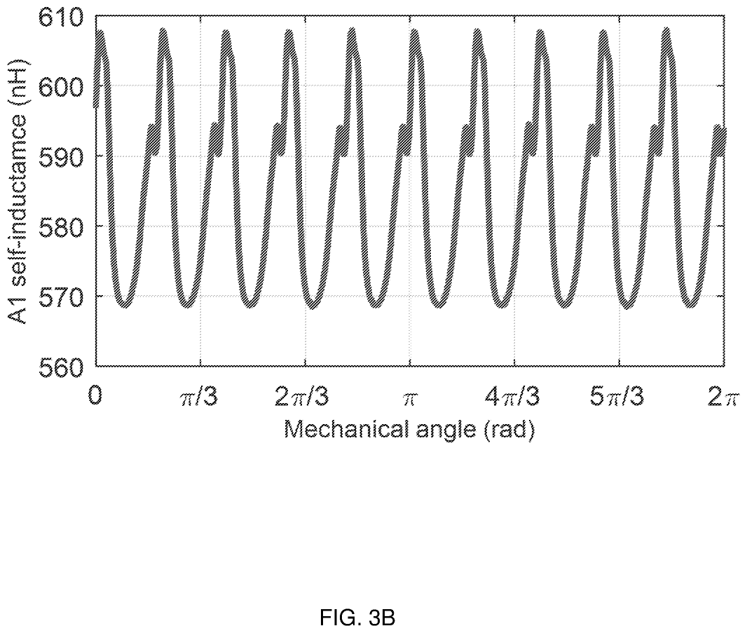

The proposed configuration is implemented in the SPM tooth-wound fractional slot concentrated winding (FSCW) motor with 12 slot and 10 poles illustrated in FIGS. 1A-1C. The geometric parameters of the case study motor are given in Table I. The motor is driven with a six-phase VSI to operate in the maximum torque per ampere (MTPA) condition. The nominal operating conditions for the case study motor are given in Table II. FIGS. 2A-2B compares the conventional machine, which shares the same geometric parameters, and the machine with the proposed winding arrangement. All turns in each phase are connected in series for each motor. Because the proposed machine has six phases, rather than the three phases in the conventional machine, the proposed machine has half as many turns per phase as the conventional machine. Thus, the conventional machine has twice the operating voltage of the proposed machine. FIGS. 3A-3B shows the back-emf and self-inductance of one turn in the position closest to the slot opening.

TABLE I
GEOMETRIC PARAMETERS OF THE CASE STUDY MOTOR

| Parameter | Value | Unit |
|---|---|---|
| Outer/inner diameter of stator | 134/81 | mm |
| Outer/inner diameter of rotor | 80/35 | mm |
| PM thickness | 5 | mm |
| Core stack length | 100 | mm |
| Air gap length | 0.5 | mm |
| Stator slot opening depth/width | 1/4 | mm |
| Stator slot depth/width | 12/10 | mm |
| Number of stator slots | 12 | — |
| Conductor cross sectional area | 11.5 | mm² |

TABLE II
NOMINAL OPERATING CONDITIONS
FOR THE PROPOSED MOTOR

| Parameter | Value | Unit |
|---|---|---|
| Average output torque | 18.8 | Nm |
| Rotational speed | 6000 | rpm |
| RMS phase voltage | 36.1 | V |
| RMS phase current | 59.8 | A |

B. Results

While the proposed configuration can eliminate ITSC faults, phase-phase faults can still occur. Based on the proposed winding configuration, two major types of short circuit fault that can happen. The first type of fault is An-Xn, where the fault occurs at the same position in both phases. The second type of fault is A(n+1)-Xn or An-X(n+1), where there is a one-turn difference in position for the fault location in the two phases. (Similar behavior would occur for faults involving phases B and Y or phases C and Z.)

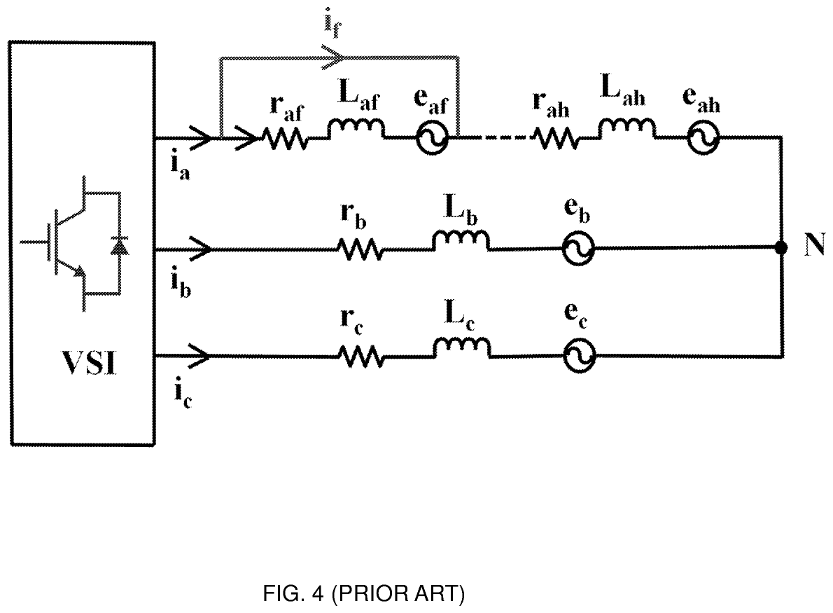

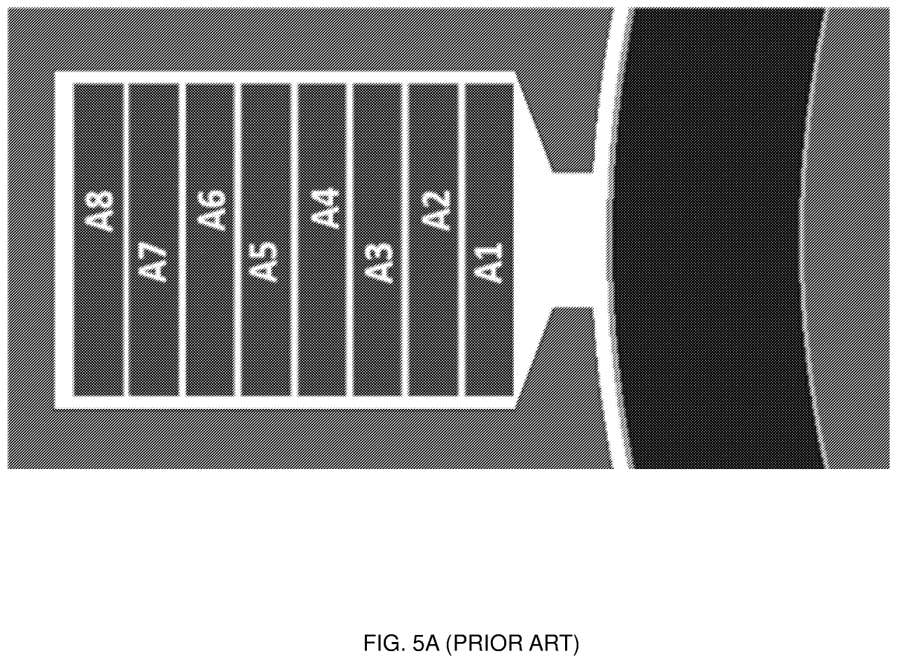

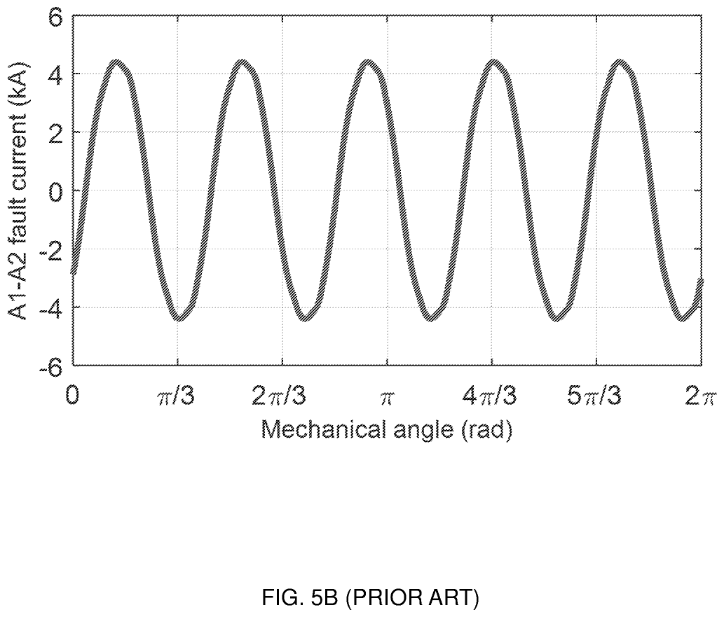

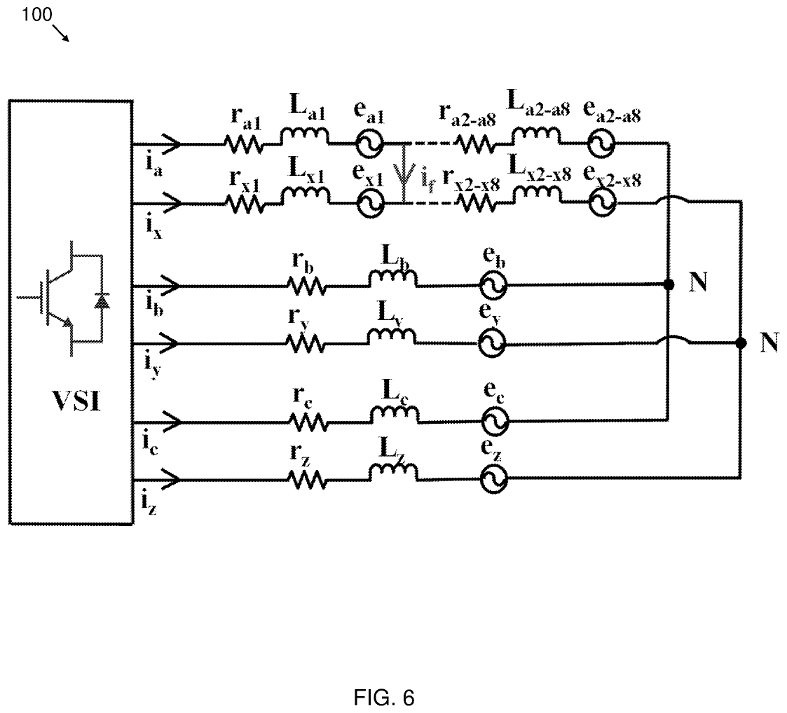

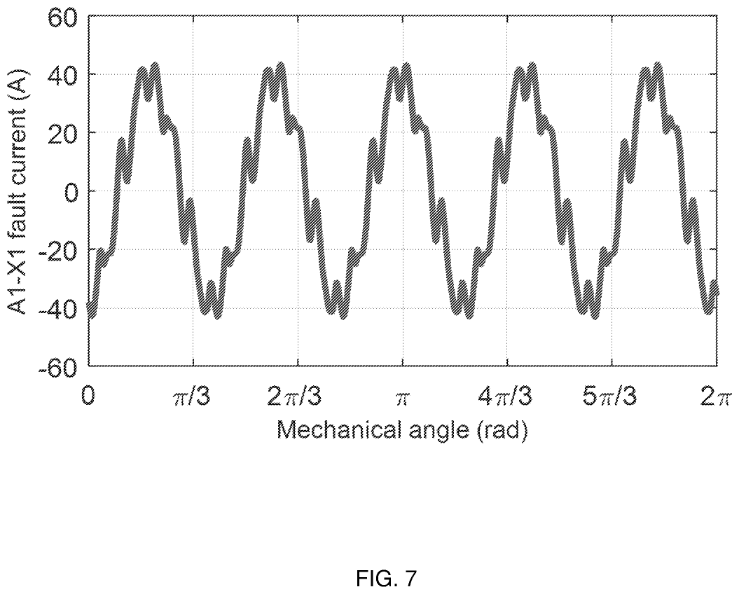

FIG. 4 illustrates the equivalent circuit model of the conventional three-phase PMSM with an ITSC fault in phase A, and FIGS. 5A-5B show the placement of the conductors in one of the slots according to the conventional arrangement with the resulting fault current when there is a short-circuit from turn A1 to turn A2, based on FEA. The RMS fault current for conventional arrangement can exceed 3.2 kA (5400% of the nominal phase current), which is completely unacceptable and, if not mitigated, will cause catastrophic failure. FIG. 6 shows the equivalent circuit model of the proposed winding configuration for an A1-X1 fault, which corresponds to the same position in the slot as the A1-A2 fault for the conventional motor. FIG. 7 shows the resulting fault current if the VSI continues to supply the nominal voltages. The RMS fault current has been decreased significantly to 27.7A, 46% of the motor nominal current. The reason for such a significant reduction in the fault current is that the back-emfs in turns A1 and X1 (ea1 and ex1, respectively) almost exactly cancel each other out in the fault current path. While we expect to have close to zero fault current, there is still a nonnegligible amount of current flowing through the fault. This occurs because turns A1 and X1 have slightly different flux linkages, due to their different positions in the slot, so the back-emfs do not completely cancel each other out. Similarly, the different locations in the slot also result in a small difference between the self-inductances of A1 and X1.

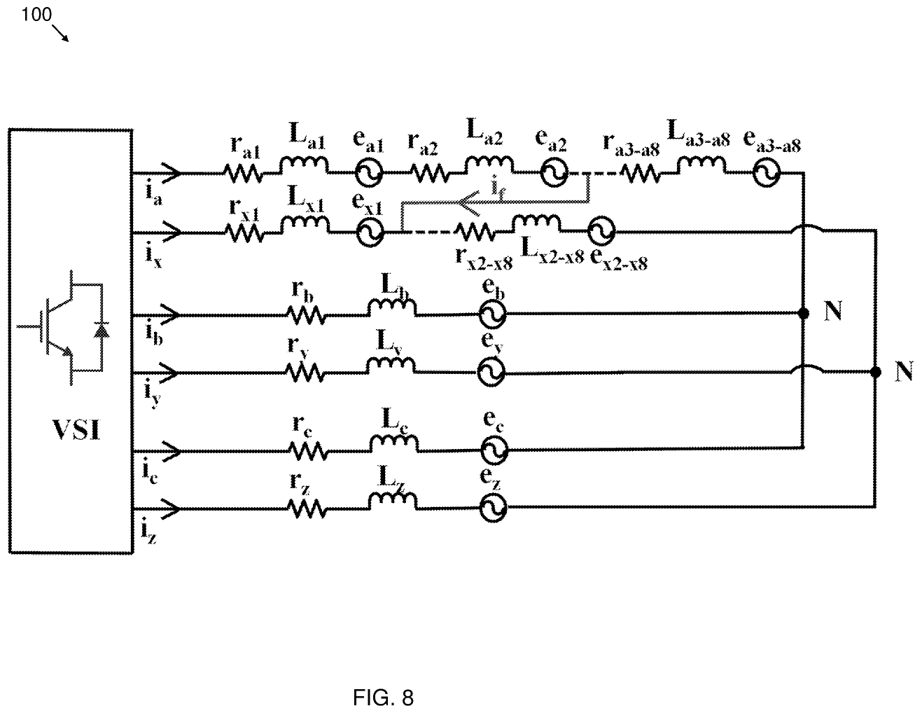

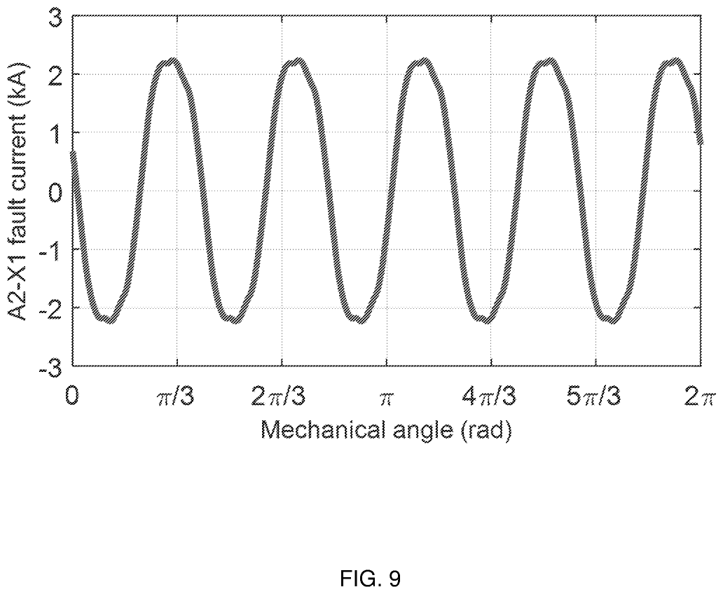

The other possible type of short circuit fault in the proposed structure occurs when there is one more turn involved in the fault loop for one of the affected phases than the other affected phase. For example, A2-X1 is such a fault, as shown in the equivalent circuit of FIG. 8. Because of the extra turn in one of the affected phases, the back-emfs no longer almost cancel each other out, so the fault current is much larger, as shown in FIG. 9. Nonetheless, the fault current is smaller than the fault current in the conventional machine. While a comparison of FIGS. 4 and 8 might indicate that the proposed arrangement would reduce the fault current to approximately one third of the fault current in the conventional arrangement, these figures do not show the mutual inductances between turns. When the mutual inductances are considered the overall inductance of the fault current path through the drive and turns A1, A2, and X1 is only slightly larger (due to leakage flux) than the inductance of a single turn.

Because the back-emfs will be unbalanced for all of the A(n+1)-Xn or An-X(n+1) faults, they are all expected to have unacceptably large fault currents. Even though the machine would need to stop operating in these cases, the proposed winding arrangement still eliminates the potential for a rapid, uncontrolled temperature rise in the motor, which would occur in a conventional SPM motor as the kinetic energy of the system is converted into heat through the ITSC fault current. If the machine were driven by a CSI, it could continue operating. Alternatively, if open-end windings supplied by full-bridges were used, the system could continue operating with phases B, Y, C, and Z.

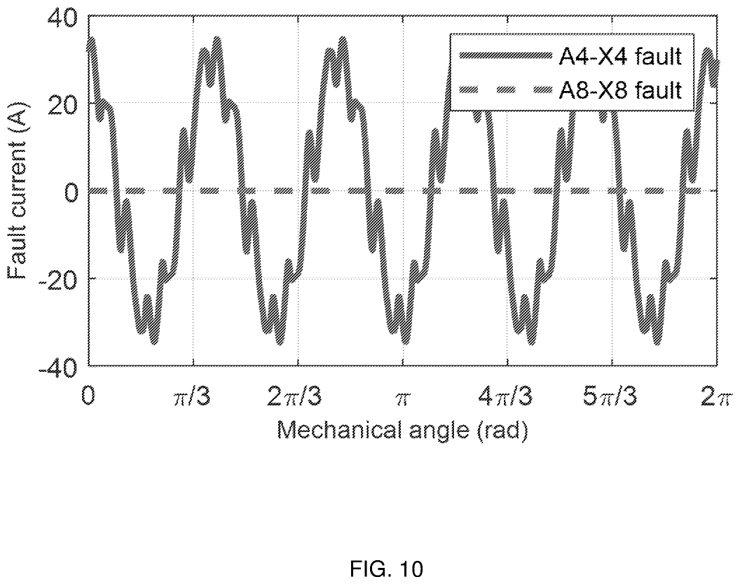

Nonetheless, other An-Xn short circuit scenarios can be interesting to consider because increasing the number of turns in the fault current path increases the resistance in the short-circuit current path. Additionally, turns that are deeper in the slot have larger inductances than those near the slot opening. FIG. 10 shows the fault currents for A4-X4 and A8-X8 faults.

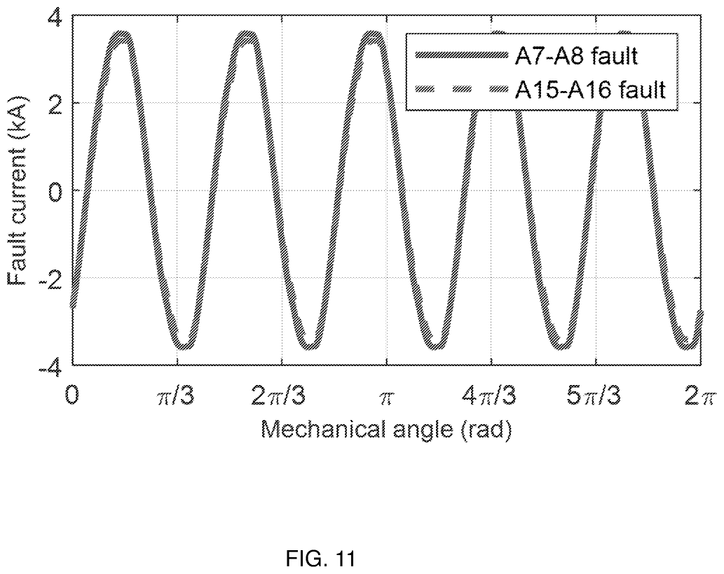

As can be seen from FIG. 10, in the proposed winding structure, the fault current decreases as the fault moves further away from the VSI. Thus, for A8-X8, which is essentially a fault between the neutral points, the fault current is practically zero. There are two reasons for this decrease. First, as the fault moves further from the drive the inductance of the fault current path increases, largely due to leakage inductances that are not cancelled out by the mutual inductances between the A and X turns. Second, the positions of the second half of the turns are reversed relative to the first half of the turns. As shown in FIG. 1B, for the first set of turns, the phase A turns are closer to the slot opening than the corresponding phase X turns, but, for the second set of turns, the phase X turns are closer to the slot opening than the corresponding phase A turns. Based on FIGS. 5 and 11, the fault current for the conventional machine does reduce slightly for faults deep in the slot, due to the increased leakage inductance. (In the conventional machine, A8 and A16 are the turns deepest in the slots, so the two fault currents in FIG. 11 are very similar.) Nonetheless, no matter how far from the source, the ITSC fault current for the conventional winding arrangement is still in the range of a few kA, which could be extremely destructive.

C. Voltage Compensation for Mitigating Fault Current

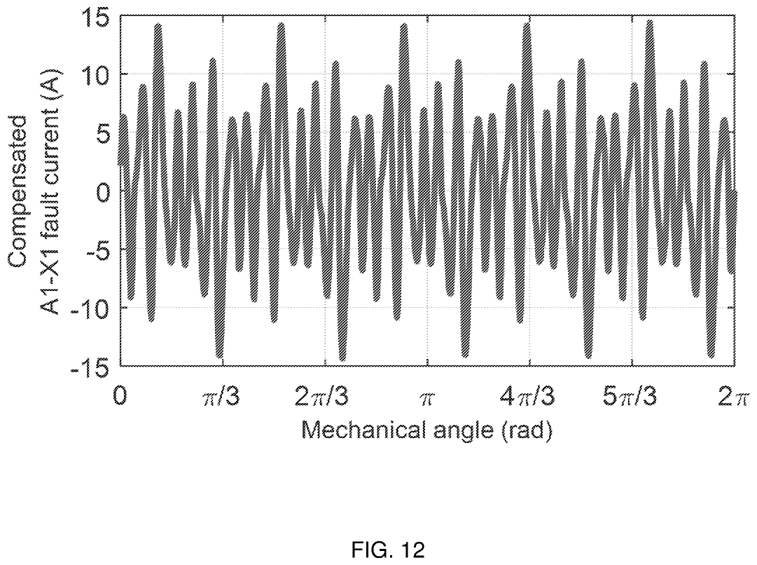

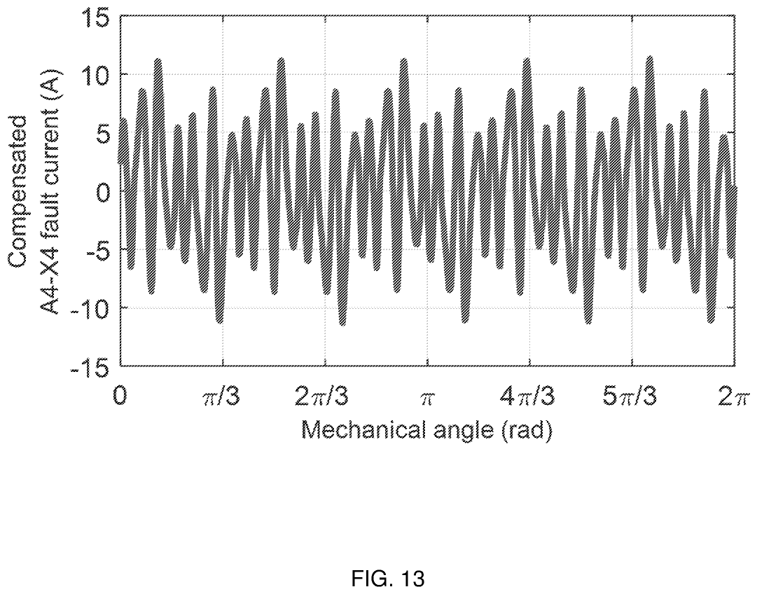

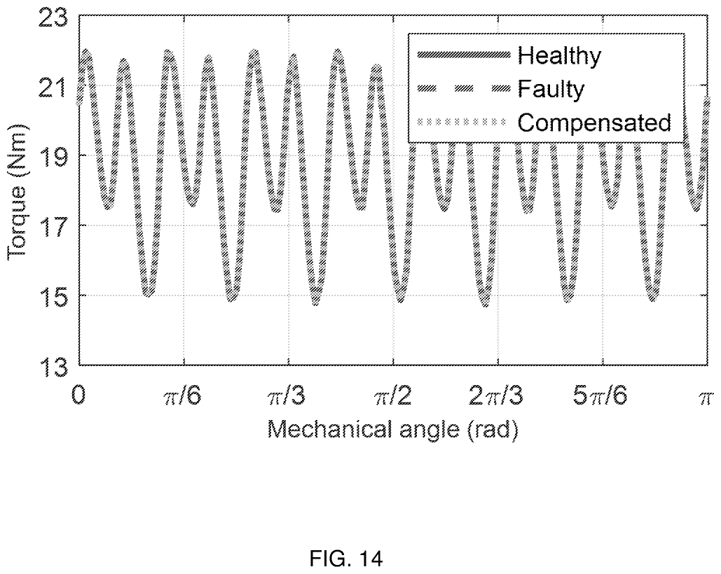

In the conventional three-phase winding configuration, the ITSC fault cannot be directly measured. Hence, it is difficult to perform any control action to mitigate the fault. On the other hand, in the proposed configuration the fault current can be easily measured. Since the two three-phase sets do not share a common neutral point, the sum of currents in each of the three-phase sets should be zero. If there is any fault current in the system, the sum of the three-phase currents will be equal to the fault current, rather than zero. If the fault current is known, control actions can be performed to reduce the fault current to the point that motor can fully continue its normal operation. The simplest way to do this is by comparing the fault current to a zero-reference current. Then, a PI or hysteresis controller can be employed to adjust the gate signals for the faulty phases. Since phases A and X are driven by different legs of the VSI and do not share a common neutral point, the fault current can be reduced to the point that motor can operate almost normally by properly adjusting the PWM signals for the faulty phases. In the case of the A1-X1 fault, the fundamental component of the fault current can be significantly reduced by introducing a very small phase shift in the voltage supplied to phase A or X. FIG. 12 shows the resulting fault current. For the conventional winding arrangement, an ITSC fault produced an RMS short circuit current 5400% of the rated current. With the proposed winding arrangement, the fault current was reduced to 46% of the rated current, and slightly adjusting the voltages supplied to the affected phases reduced the fault current to 10.5% of the rated current. In this situation, the motor can continue operating almost normally. FIG. 13 shows the fault current of the A4-X4 after compensation. (No compensation is necessary for the A8-X8 fault.) Similar control action can be performed for other faults. FIG. 14 shows the torque waveforms for the healthy motor, the motor with the A1-X1 fault before voltage compensation, and the A1-X1 fault after voltage compensation, respectively. Because the fault current circulates through phase A and phase X, it produces a minimal impact on the magnetic fields in the motor and, thus, does not significantly affect the torque. Additionally, the slight phase shift in voltage to reduce the fault current produces a negligible impact on torque.

In this disclosure, a multiphase winding arrangement in which any ITSC fault becomes a phase-phase fault was introduced. This allows the drive to block the fault current. Different short-circuit fault scenarios were evaluated for a case study SPM machine. The results showed that, in some short-circuit scenarios where the back-emfs approximately cancel out each other, the fault currents are reduced from 5400% of the nominal current for the conventional winding arrangement to only 46% in the proposed winding. Additionally, the fault current can be further reduced to 10.5% of the nominal current by slightly adjusting the voltages supplied to the affected phases and the motor can continue its normal operation without even disconnecting the affected phases. In other cases, where the fault occurs between different positions in two phases, the inverter can disconnect the affected phases to prevent dangerous fault currents. Future work will include experimental validation.

### REFERENCES

(1) M. Zafarani, E. Bostanci, Y. Qi, T. Goktas, and B. Akin, “Interturn Short Circuit Faults in Permanent Magnet Synchronous Machines: An Extended Review and Comprehensive Analysis,” IEEE Trans. Emerg. Sel. Topics Power Electron., vol. 6, no. 4, pp. 2173-2191, December 2018.
(2) B. A. Welchko, T. A. Lipo, T. M. Jahns, and S. E. Schulz, “Fault tolerant three-phase AC motor drive topologies: a comparison of features, cost, and limitations,” IEEE Trans. Power Electron., vol. 19, no. 4, pp. 1108-1116, July 2004.
(3) A. Morya and H. A. Toliyat, “Insulation design for Wide Bandgap (WBG) device based voltage source converter fed motors,” in Proc. IEEE 5th Workshop Wide Bandgap Power Devices Appl., 2017, pp. 74-79.
(4) Y. Qi, E. Bostanci, M. Zafarani, and B. Akin, “Severity Estimation of Interturn Short Circuit Fault for PMSM,” IEEE Trans. Ind. Electron., vol. 66, no. 9, pp. 7260-7269, September 2019.
(5) Y. Qi, E. Bostanci, V. Gurusamy, and B. Akin, “A Comprehensive Analysis of Short-Circuit Current Behavior in PMSM Interturn Short-Circuit Faults,” IEEE Trans. Power Electron., vol. 33, no. 12, pp. 10784-10793, December 2018.
(6) Z. Q. Zhu and D. Howe, “Electrical machines and drives for electric, hybrid, and fuel cell vehicles,” Proc. IEEE., vol. 95, no. 4, pp. 746-765, April 2007.
(7) Z. Sun, J. Wang, D. Howe, and G. Jewell, “Analytical prediction of the short-circuit current in fault-tolerant permanent-magnet machines,” IEEE Trans. Ind. Electron., vol. 55, no. 12, pp. 4210-4217, December 2008.
(8) J. Chai, J. Wang, Z. Sun, and D. Howe, “Analytical prediction of interturn short-circuit current in fault-tolerant permanent magnet brushless machines,” in Proc. 4th IET Int. Conf. Power Electron., Mach. Drives, 2008, pp. 1-5.
(9) H. Qian, H. Guo, and X. Ding, “Modeling and analysis of interturn short fault in permanent magnet synchronous motors with multistrands windings,” IEEE Trans. Power Electron., vol. 31, no. 3, pp. 2496-2509, March 2016.
(10) L. Romeral, J. C. Urresty, J.-R. R. Ruiz, and A. G. Espinosa, “Modeling of surface-mounted permanent magnet synchronous motors with stator winding interturn faults,” IEEE Trans. Ind. Electron., vol. 58, no. 5, pp. 1576-1585, May 2011.
(11) E. Levi, “Advances in converter control and innovative exploitation of additional degrees of freedom for multiphase machines,” IEEE Trans. Ind. Electron., vol. 63, no. 1, pp. 433-448, January 2016.
(12) H. S. Che, M. Duran, E. Levi, M. Jones, W. Hew, and N. A. Rahim, “Post-fault operation of an asymmetrical six-phase induction machine with single and two isolated neutral points,” IEEE Trans. Power. Electron., vol. 29, no. 10, pp. 5406-5416, October 2014.
(13) W. N. W. A. Munim, M. J. Duran, H. S. Che, M. Bermudez, I. Gonzalez-Prieto, and N. A. Rahim, “A unified analysis of the fault tolerance capability in six-phase induction motor drive,” IEEE Trans. Power Electron., vol. 32, no. 10, pp. 7824-7836, October 2017.
(14) A. S. Abdel-Khalik, M. S. Hamad, and S. Ahmed, “Postfault operation of a nine-phase six-terminal induction machine under single open-line fault,” IEEE Trans. Ind. Electron., vol. 65, no. 2, pp. 1084-1096, February 2018.
(15) M. Farhadi, M. T. Fard, M. Abapour and M. T. Hagh, “DC-AC Converter-Fed Induction Motor Drive With Fault-Tolerant Capability Under Open- and Short-Circuit Switch Failures IEEE Trans. Power Electron., vol. 33, no. 2, pp. 1609-1621, February 2018.
(16) A. Gandhi, T. Corrigan, and L. Parsa, “Recent advances in modeling and online detection of stator interturn faults in electrical motors,” IEEE Trans. Ind. Electron., vol. 58, no. 5, pp. 1564-1575, May 2011.
(17) T. Hamiti, P. Arumugam, and C. Gerada, “Turn-turn short circuit fault management in permanent magnet machines,” IET Electr. Power Appl., vol. 9, no. 9, pp. 634-641, November 2015.
(18) M. Dai, A. Keyhani, and T. Sebastian, “Fault analysis of a PM brushless DC Motor using finite element method,” IEEE Trans. Energy Conyers., vol. 20, no. 1, pp. 1-6, March 2005.

(19) B.-G. Gu, J.-H. Choi, and I.-S. Jung, “A dynamic modeling and a fault detection scheme of a PMSM under an inter turn short,” in Proc. IEEE Veh. Power Propuls. Conf., 2012, pp. 1074-1080.
(20) V. Gurusamy, E. Bostanci, C. Li, Y. Qi, and B. Akin, “A Stray Magnetic Flux-Based Robust Diagnosis Method for Detection and Location of Interturn Short Circuit Fault in PMSM,” IEEE Trans. Instrum. Meas., vol. 70, pp. 1-11, 2021.
(21) M. Afshar, A. Tabesh, M. Ebrahimi, and S. A. Khajehoddin, “Stator Short-Circuit Fault Detection and Location Methods for Brushless DFIMs Using Nested-Loop Rotor Slot Harmonics,” IEEE Trans. Power Electron., vol. 35, no. 8, pp. 8559-8568, August 2020.
(22) P. C. Palavicino, W. Lee, and B. Sarlioglu, “Detection and Compensation of Inter-turn Short Circuit in Interior Permanent Magnet Synchronous Machines with 2-level Voltage Source Inverter,” in Proc. IEEE Energy Conyers. Congr. Expo., 2020, pp. 4460-4465.
(23) Y. Xu, Z. Zhang, Y. Jiang, J. Huang, and W. Jiang, “Numerical Analysis of Turn-to-Turn Short Circuit Current Mitigation for Concentrated Winding Permanent Magnet Machines With Series and Parallel Connected Windings,” IEEE Trans. Ind. Electron., vol. 67, no. 11, pp. 9101-9111, November 2020.
(24) Y. Zhao, D. Li, T. Pei, and R. Qu, “Overview of the rectangular wire windings AC electrical machine,” CES Transactions on Electrical Machines and Systems, vol. 3, no. 2, pp. 160-169, June 2019.
(25) Y. B. Deshpande, H. A. Toliyat, S. S. Nair, S. Jabez Dhinagar, S. Immadisetty, and S. Nalakath, “High-Torque-Density Single Tooth-Wound Bar Conductor Permanent-Magnet Motor for Electric Two Wheeler Application,” IEEE Trans. Ind. Electron., vol. 51, no. 3, pp. 2123-2135, May-June 2015.

Those skilled in the art to which this application relates will appreciate that, based on the present disclosure, other and further combinations, additions, deletions, substitutions and modifications may be made to the described embodiments.

What is claimed is:

1. An electrical machine comprising:
a stator, the stator including slots to house conductors, the conductors arranged in the slots to provide a winding arrangement wherein:
turns of a first conductor winding are not adjacent to each other,
turns of a second conductor winding are not adjacent to each other, and
the turns of the first conductor winding and the turns of the second conductor winding do not share a common neutral point and are not connected to each other in series or parallel.

2. The electrical machine of claim 1, wherein the turns of the first conductor are interleaved with the turns of the second conductor.

3. The electrical machine of claim 1, further including a rotor wherein the stator is situated within the rotor.

4. The electrical machine of claim 1, further including a rotor wherein the stator is situated axially beyond the rotor.

5. The electrical machine of claim 1, further including a rotor wherein the stator is situated around the rotor.

6. The electrical machine of claim 5, wherein the rotor includes a permanent magnet.

7. The electrical machine of claim 5, wherein the rotor includes permanent magnets that are arranged to have opposite polarity alignments with respect to each other.

8. The electrical machine of claim 1, wherein the electrical machine includes a motor.

9. The electrical machine of claim 1, wherein the electrical machine includes a generator.

10. The electrical machine of claim 1, further including a current source inverter to drive the electric machine with the winding arrangement.

11. The electrical machine of claim 1, further including a voltage source inverter to drive the electric machine with the winding arrangement.

12. The electrical machine of claim 11, wherein a magnitude or a phase of a voltage supplied by the voltage source inverter to one of the first conductor or to the second conductor is different from the magnitude or a phase of a voltage supplied by the voltage source inverter to the other one of the second conductor or to the first conductor.

13. The electrical machine of claim 11, further including an inductor or a choke connected between the voltage source inverter and the first conductor or the second conductor.

14. The electrical machine of claim 11, further including an inductor or a choke connected to a DC voltage line to the voltage source inverter.
